(19) United States
(12) Patent Application Publication
(10) Pub. No.: US 2024/0260541 A1
(43) Pub. Date: Aug. 8, 2024

(54) LIVESTOCK MOTIVATION DEVICE

(71) Applicant: John EMMONS, DIXON, MO (US)

(72) Inventor: John EMMONS, DIXON, MO (US)

(21) Appl. No.: 18/411,932

(22) Filed: Jan. 12, 2024

Related U.S. Application Data
(60) Provisional application No. 63/479,766, filed on Jan. 13, 2023.

(51) Int. Cl. A01K 15/00

(52) U.S. Cl. CPC A01K 15/003

(57) ABSTRACT

A livestock motivation device comprising a compressed gas module, elongate tube, and plurality of noise-making tips is disclosed. The user points the elongate tube with noise-making tip, through which compressed gas is passaged, at the livestock. Passage of compressed gas through the noise-making tip generates a motivating sound, and impingement of flowing gas against the livestock's body provides gentle motivation.

### CROSS-REFERENCE TO RELATED APPLICATIONS

The application claims priority to U.S. App. No. 63/479,766 filed Jan. 13, 2023, and which is incorporated herein by reference.

### STATEMENT REGARDING FEDERALLY SPONSORED RESEARCH OR DEVELOPMENT

Not Applicable.

### BACKGROUND

The subject matter described herein relates generally to an improved livestock motivator.

Livestock motivators describe a broad class of tools that have long been used in the field of animal husbandry for motivating livestock to move. The needs of modern animal husbandry often require routine movement of large numbers of livestock through passages and to areas, such as holding pens. Livestock can be stubborn, however. Cattle in particular are broadly known to be difficult to move, and much research has been dedicated to adapting farm environments to better suit our understanding of cattle psychology.

Traditional livestock motivation has focused on corralling or directly agitating the livestock. Thus, possibly the most well-known livestock motivators are herding dogs, enclosed paths, and cattle prods. Herding dogs are not well suited for all farm environments or all species of livestock, however, and can represent a considerable expense in time, training, and care. Sometimes, blinder-like structures and enclosed paths are used to better guide livestock movements. Psychological research into cattle has found that blinder-like structures and enclosed paths can dissuade cattle from freezing in place out of fear of something unknown in their environment. However, such structures, while possibly offering their own benefit, do not better enable the use of herding dogs.

Cattle prods are another type of motivator that are commonly used. A cattle prod is a generally linear tool that is used to motivate cattle by striking or poking them. Although cattle prod designs can be exceedingly simple, the most popular iteration, an electric cattle prod, is capable of introducing a high voltage yet low current shock. Electric cattle prods typically have an electrified tip which, when the electrified tip contacts cattle, produces an electric shock, the surprise and pain of which motivates cattle to move forward. However, some view electric cattle prods as being inhumane, and thus, much of modern industry has moved away from their use.

Nevertheless, electric prods are capable of providing direct, immediate motivation in a way that carefully designed structures and well-trained herding dogs are not. Thus, there exists a need for a livestock motivation device that can be employed in a wide variety of settings, that produces immediate, short-term motivation, with no need for additional training, and that does so effectively and more humanely.

### BRIEF SUMMARY

Disclosed herein is a livestock motivation device for aiding in spurring immediate, short-term movement of livestock. In one embodiment, the device comprises a compressed gas module that comprises a source of compressed gas and an outlet, an actuator that is operably connected to the compressed gas module, an elongate tube extending from the actuator, and a removable noisemaking tip affixed to the distal end of the elongate tube. The actuator comprises a valve that can be switched between ‘open’ and ‘closed’ positions, wherein the valve defaults to the ‘closed’ position. Thus, operation of the actuator opens the valve and permits compressed gas to leave the compressed gas module through the outlet and into an inlet of the elongate tube. That compressed gas then travels through the elongate tube and through the noisemaking tip, thereby shaping the flow of gas and generating noise from that gas flow.

The compressed gas module may be a removable canister of compressed gas. Alternatively, the compressed gas module may comprise an air compressor and a reservoir positioned between the gas compressor and the inlet of the elongate tubing. In a variation, the reservoir can be omitted, such that the air compressor is in direct communication with the inlet of the elongate tubing.

The removable noisemaking tip can assume a variety of designs. The tip comprises an inlet attached to the distal end of the elongate tube, a hollow interior passage, and an outlet opposite the inlet. More specific tip designs include a ‘whistle tip,’ a ‘rattler tip,’ a ‘moo tip,’ and a ‘reed slide tip.’ The whistle tip comprises a whistle that is integrated into the noisemaking tip, such that during use, the gas flows through whistle, generating a whistle sound or noise. The rattler tip comprises a hollow chamber containing a plurality of small loose objects that are agitated by the flow of gas and thereby produce a rattling noise. The moo tip comprises one or more reeds, such that passage of gas causes the reed or reeds to vibrate and thereby generate noise. The reed slide tip is similar to the moo tip, but further comprises an adjustable sliding clamp that impinges on a reed. By sliding the clamp back and forth, the effective vibrational frequency of the reed can be adjusted, thereby adjusting the pitch of the sound generated when gas is passaged over the reed.

The livestock motivation device can also be sold as part of a kit that includes a plurality of tips of varying design.

### BRIEF DESCRIPTION OF THE DRAWINGS

FIGS. 1A-B are opposing side views of a livestock motivator.

FIG. 2 is a fragmentary side view of the livestock motivator, showing a compressed air module and actuator of the motivator.

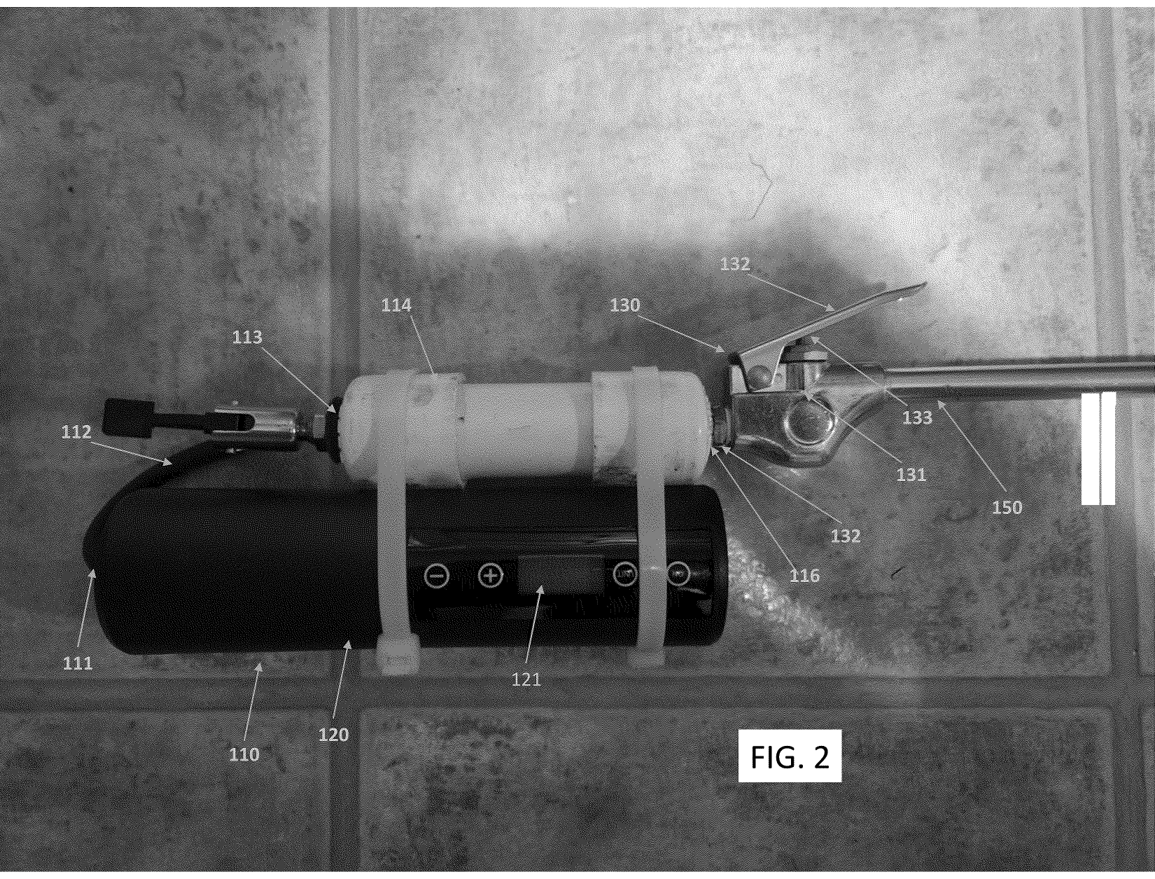

FIG. 3 is a fragmentary side view of a tip end of the livestock motivator with a tip mounted thereon.

FIGS. 4A-D are side views of exemplary embodiments of noise making tips, detached from the outlet of the elongate tube, which are securable to the motivator.

FIG. 5 is a diagrammatic depiction of an exemplary embodiment of a noise making tip that can easily adjust the pitch of its sound output.

FIG. 6 is an alternative embodiment of the livestock motivator wherein the livestock motivator including a portable power supply for an air compressor of the cattle motivator.

FIG. 7 is a view of an alternative embodiment of the cattle motivator wherein the compressed gas module omits the reservoir; the cattle motivator being disassembled, and the compressed gas module being opened.

FIG. 8 is an enlarged view of the compressed gas module of the cattle motivator of FIG. 7.

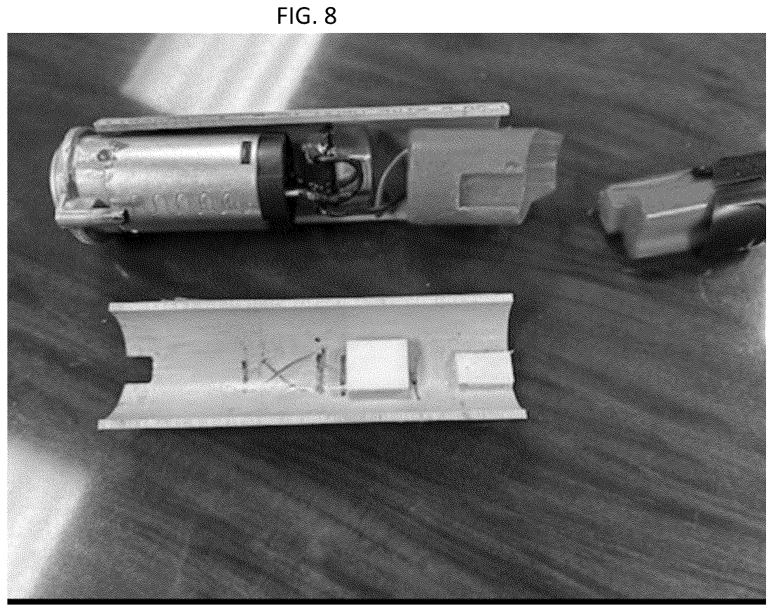

FIG. 9 is a view of the cattle motivator of FIG. 7 when assembled.

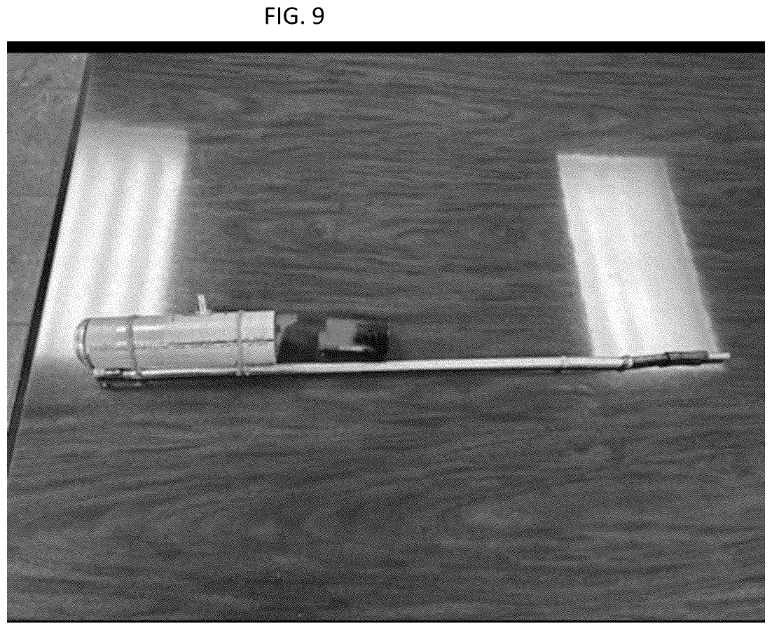

Corresponding reference numerals will be used throughout the several figures of the drawings.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what I presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

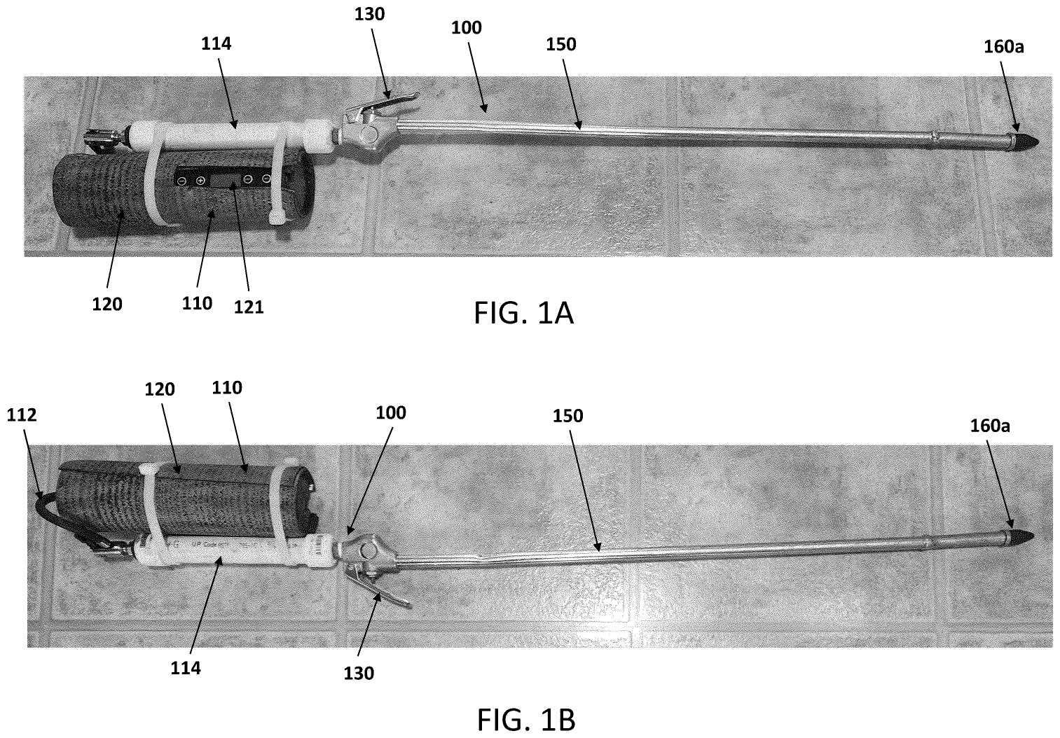

A livestock motivator 100 is shown generally in FIGS. 1A-B. The livestock motivator comprises a compressed gas module 110. The compressed gas module 110 is preferably sized and disposed to be relatively easily carried by a person of average strength. The compressed gas module, as shown, comprises an electrically powered gas compressor 111 (such as a portable air pump). The gas compressor may be of any design known in the art, including dynamic and positive displacement. The compressor 111 comprises a control and/or informational panel 121 on an exterior surface of the gas compressor. The control panel 121 has a user interface that comprises power on/off options, gas pressure adjustment options, and other options known to practitioners of the art. A power supply 120 can be integrated into the gas compressor 111. Alternatively, the compressed gas module 110 can be a canister of compressed gas, nominally sealed to prevent the release of compressed gas when the device is not in use.

The compressed gas module includes an outlet 110a to which a tubing 112 is connected. Preferentially, the tubing is in the form of a flexible hose. The tubing then may connect to an inlet 113 of a reservoir 114 in embodiments featuring a reservoir. Preferentially, the tubing 112 is detachable from the reservoir inlet 113.

If an external reservoir is incorporated, the reservoir 114 is an enclosed container for holding a volume of compressed gas. Preferentially, the reservoir 114 is a substantially cylindrical container made of a rigid polymer such as polyvinyl chloride (PVC). The reservoir 114 may take other forms and be made of other materials, however, so long as the reservoir is still capable of holding a volume of compressed gas. The reservoir 114 has an outlet 116 at an end opposite the reservoir inlet 113 to which an actuator 130 is operably connected, for example, by means of a threaded connector 132. The actuator 130 comprises a valve 131 having a valve member which moves between an open position and a closed position. Preferably, the valve is normally closed (i.e., it defaults to closing the reservoir outlet), and use of the actuator 130 may toggle the valve between its closed and open positions. The actuator 130 further comprises a lever 132 that is positioned over the valve 131. Pressing the lever 132 causes the lever to impinge on a pin 133, which in turn opens the valve 131. When the lever 132 is released, the pin 133 rises due to the pressure within the valve and the valve 131 closes. Alternatively, the lever 132 can be spring biased, so that upon release of the lever, the spring will raise the lever, allowing the valve to close. Seals can be positioned between the reservoir outlet and the actuator to provide for air-tight connections between the respective elements. The actuator could take many other forms. For example, the actuator 130 could comprise buttons or levers. Further, the actuator could be located anywhere on the device that is reasonably accessible to the user.

An elongate, preferably, rigid tube 150 extends from the actuator 130. A seal can be provided between the actuator and the elongate tube 150 to provide for air-tight connections between the respective elements. Although shown in FIG. 1 to be generally straight, the elongate tube 150 could be curved. The elongate tube 150 defines a passage which can be, for example as much as between three and even six feet long, and through which gas released from the reservoir 114 passes when the actuator is activated. Gas passing through the elongate tube 150 exits at an outlet 152 at a distal end 153 of the elongate tube 150.

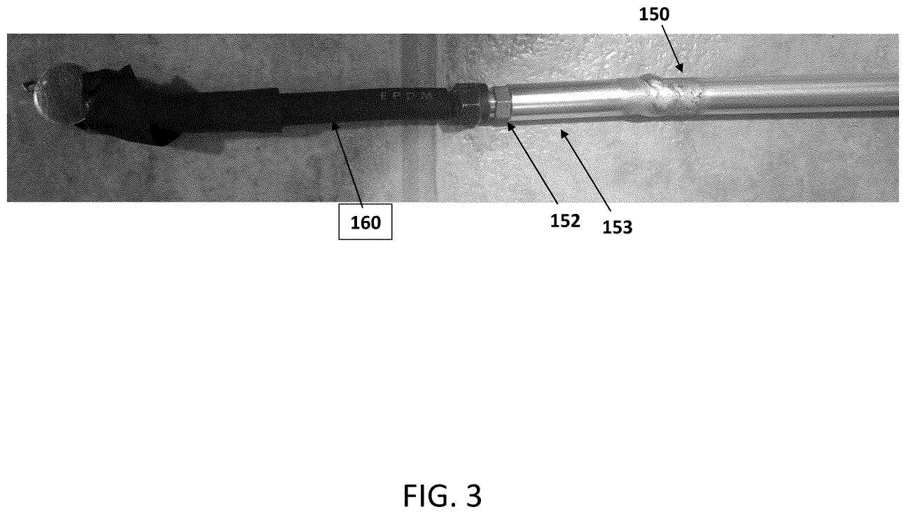

FIG. 3 shows a tip 160 mounted to the outlet 152 of the tube 150. The tip 160 is removably mounted to the elongate tube 150. For example, the distal end of the tube 150 can be threaded, and the tip 160 can comprise a threaded connector 161 that allows for removable mounting of the tip to the tube 150. An extension tubing 162 extending from the connector 161 and a whistle 163 is secured at the end of the extension tubing. The whistle 163 defines an outlet 165 for the tip 160. The threaded connector 161 defines a hollow passage which is in communication with the passage of the elongate tube 150. Thus, air from the module, or from the module and reservoir, passes through the tube 150 into the tip 160 to pass through the whistle 163. The extension tubing 162 further extends a distance from the tube inlet 151 to the tip outlet 165, and can be sized to accommodate the needs of the user. The extension tubing 162 may be curved, and it may be flexible, to better suit the needs of the user. The whistle 163 is secured to the extension tubing 162 and comprises an interior chamber sized and disposed to receive gas flow passing through the extension tubing 162 from the elongate tube 150. The interior chamber of the whistle is contoured such that when gases flow through the interior chamber, the whistle 163 produces a high-pitched sound in a manner known to practitioners of the art.

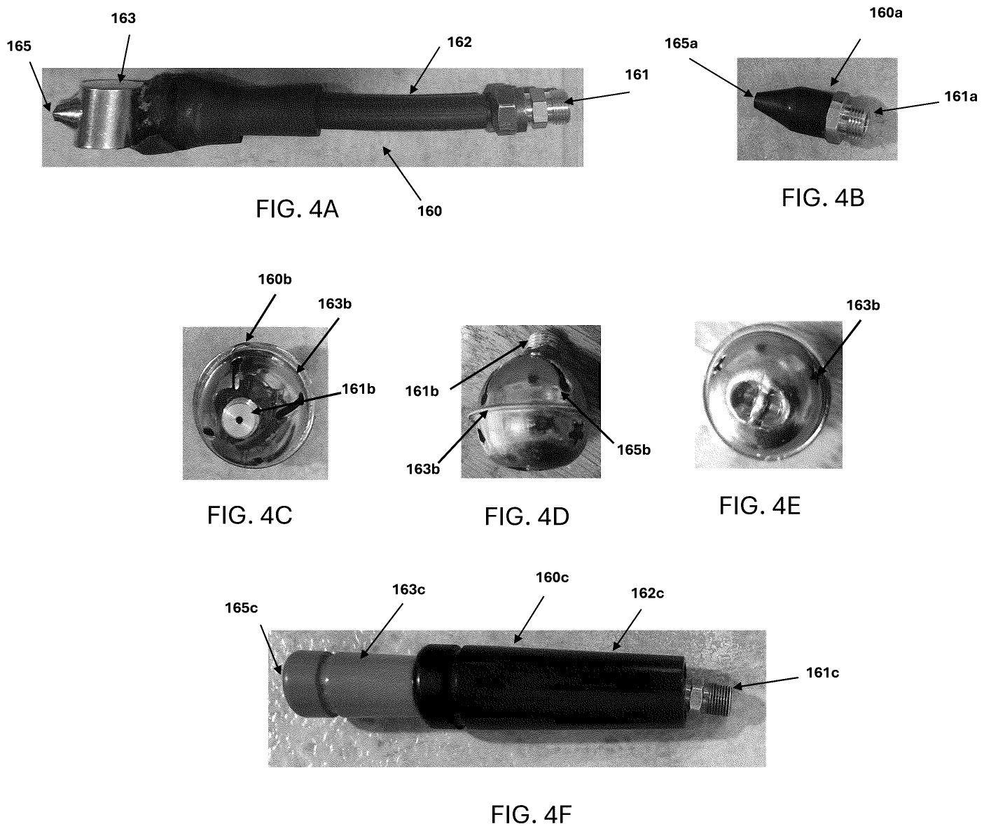

FIGS. 4B-4D show three alternative tips. FIG. 4B shows an outlet tip 160a called a “blow tip.” The blow tip comprises a threaded connector 161a and a tip outlet 165a at a distal end thereof. The blow tip 160a does not comprise an extension tubing or a whistle. Instead, the blow tip 160a simply comprises an interior passage that terminates at the tip outlet 165a. When mounted to the tube 160, the interior passage of the blow tip 160a is in communication with the tube 150. Rather than producing a high-pitched ‘whistle’ sound when compressed gas passes through it, the blow tip 160a can generate an audible low-pitch whistle.

FIG. 4C shows front, rear, and side views of an exemplary outlet tip 160b called a “rattler tip.” The rattler tip comprises a threaded connector 161b coupled to a hollow housing 163b (shown to be generally spherical) having an outlet 165 (which can be in the form of slits). The hollow housing 163b defines an interior chamber sized and disposed to receive gas flow passing from the tubing outlet 152. The interior chamber of the rattler 163b contains a plurality of loose tumblers (not shown). When gases flow through the interior chamber of the rattler 160b, the loose tumblers are agitated and collide with one another and the side of the, preferably metal, ball 163b, producing a rattling noise. Compressed gas then exits through the outlet 165b.

FIG. 4D shows an exemplary outlet tip 160c called a “moo tip.” The moo tip 160c comprises a threaded connector 161c affixed to one end of an extension tubing 162c and a reeded wildlife call 163c affixed to the other end of the extension tubing. The extension tubing 162c envelops and holds an end of the reeded wildlife call 163c, and at a distal end, the reeded wildlife call defines a tip outlet 165c. However, other means of mutual affixation known to practitioners of the art, such as by screw threading, are envisioned. When gas passes through the reeded wildlife call 163c, the reeded wildlife call generates a sound designed to imitate the call of a wild animal.

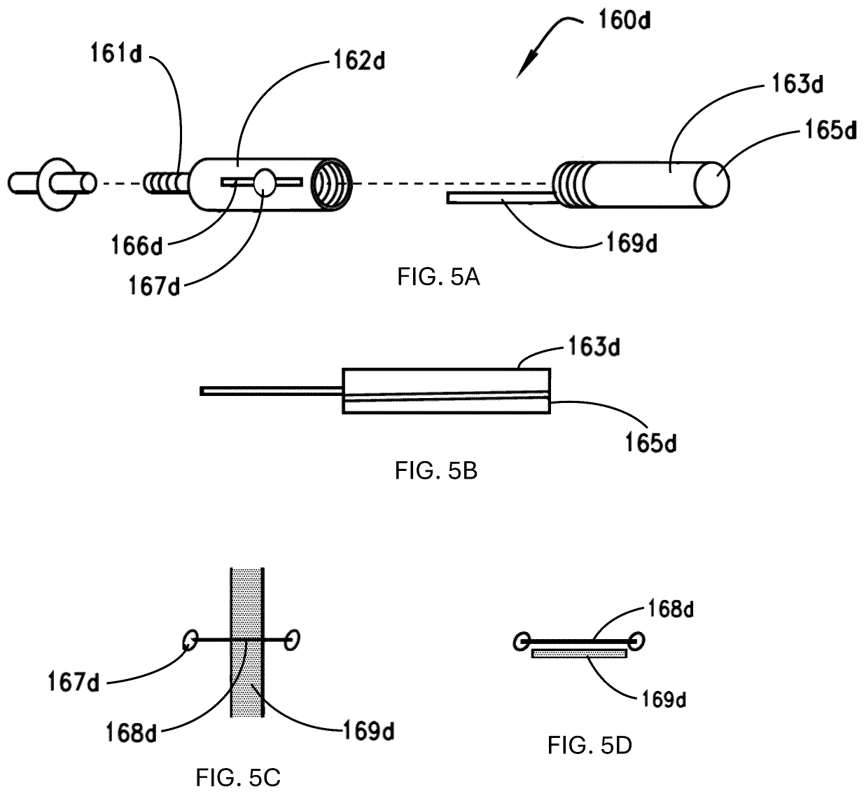

FIG. 5 shows an alternative reeded outlet tip 160d called a “reed slide tip.” The reed slide tip comprises a slide clamp chamber 162d and a reeded noisemaking tip 163d. The slide chamber comprises a threaded connector 161d at one end affixed to one end of slide clamp chamber with the reeded noisemaking tip 163d removably connected to the opposite end of the slide clamp chamber. The slide clamp chamber 162d defines a hollow cylindrical passage that is threaded at its distal end opposite the connector 161d. The slide clamp chamber 162d defines two elongated slots 166d situated on diametrically opposing sides of the slide clamp chamber. A slide 168d, in the form of a thin linear member, passes through both slots and is situated transverse to the elongated slots to be moveable along the slots. The clamp 168d comprises handles 167d on either end of the slide, with the handles being sized such that they can be easily grasped and are larger than the width of the elongated slots 166d. Thus, the elongated slots 166d, handles 167d, and slide 168d are arranged such that the slide's position can be slidably adjusted along the length of the elongated slots, but the size of the handles ensures that clamp cannot be removed from the slots. The handles 167d are fixed with respect to the slide 168d as shown, but alternately can be threaded to tighten onto slide and hold it in place by friction. The reeded noisemaker tip 163d is a hollow cylindrical chamber that has a threaded end to connect the reeded noisemaker to the slide clamp chamber 162d. The reeded noisemaker tip defines an outlet 165d at a distal end opposite the threaded end. The reeded noisemaker tip contains a reed 169d that extends substantially parallel to the length of the reeded noisemaker tip 163d. The reed 169d is mounted in the reeded noise maker tip such that a portion of the reed extends rearwardly from the threaded end of the reeded noisemaker tip. When the reeded noisemaker 163d is screwed into the slide clamp chamber 162d, the reed 169d protrudes into the slide clamp chamber such that the reed contacts the underside of the clamp 168d. The reed can be sized such that the reed extends into the slide clamp chamber beyond the rear end of the slots 166d. The user can adjust the point of contact between the clamp 168d and the reed 169d by grasping the handles 167d and sliding the clamp forward or backward along the length of the slots 166d. When gas passages through the reed slide tip 160d, the reed vibrates and thereby generates a sound. The pitch of the sound generated by passage of gas over the reed 169d is determined by the point of contact between the clamp 168d and the reed.

Although the tips 160a-d are disclosed to be threadedly connected to the distal end of the elongate tube 150, it will be apparent that the tips can be connected in other ways. For example, the tips can be received in or about the distal end of the tube, and held in place frictionally. Alternatively, a spring ball connection can be used, or a bayonet slot and pin connection can be used.

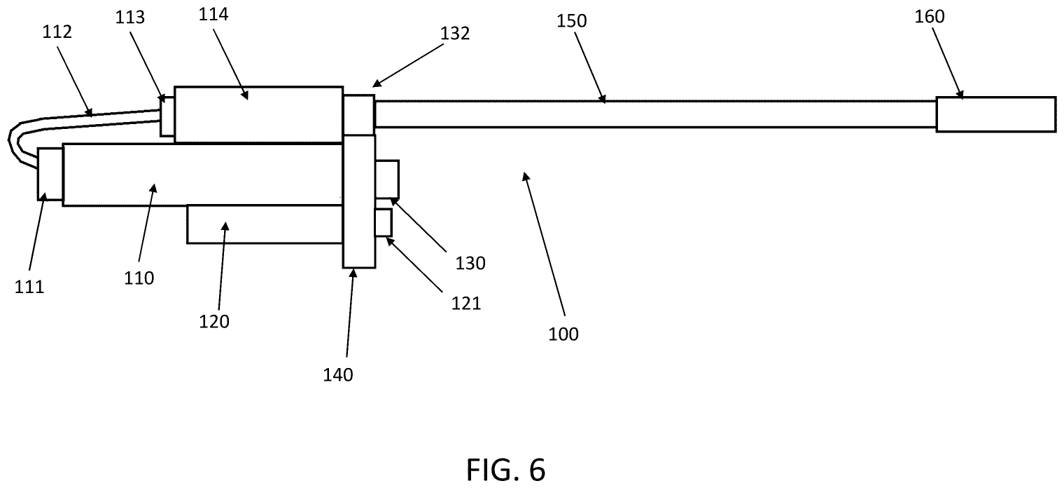

An alternative construction of the cattle motivator is shown in FIG. 6. In this alternative construction, the portable energy supply is not integrated into the compressor, rather, the portable energy supply is external of and connected to the compressor. Furthermore, a handle 140 is affixed to the cattle motivator 100. The handle can be shaped and sized to contour to a human hand, thereby better enabling a user to hold the cattle motivator. The handle 140 can be permanently affixed to the tube inlet 151 by welding or other known means. However, practitioners of the art will recognize that the handle 140 may affix to the cattle motivator 100 at numerous other locations so long as the user is able to grasp the handle to hold the cattle motivator. The actuator 130 is shown affixed to the handle such that the user's hand can both grasp the handle 140 and operate the actuator. The control panel 121 is also preferentially located on the handle 140, so that the user can use the same hand that holds the handle to easily alter settings on the compressed gas module.

During operation of the cattle motivator 100, a user grasps the device by the handle 140 and activates the compressor 120 to pressurize the reservoir 114. The user then points the tip 160 at livestock toggles the actuator 130. Use of the actuator 130 releases compressed gas from the reservoir 114, and the gas then flows through elongate tubing 150 and outlet tip 160. The flow of compressed gas contacts the livestock in question and provides gentle tactile sensation to the cattle to motivate the cattle to move. Further, the flow of gas generates noise based on the tip 160 at the end of the elongate tube 150. The totality of the device's components ideally weigh little enough for the device to be easily carried by a person of average strength. If the compressed gas module 110 is an electrically-powered gas compressor, the portable energy supply 120 enables the user to take the device anywhere in the field without need for wired connection to the electrical grid.

The provision of the reservoir 114 is advantageous in that it stores a volume of compressed gas that is ready to be released immediately upon operation of the actuator 130. Thus, the provision of the reservoir will provide for a faster flow rate of gas than might be accomplished with the compressed gas module itself. When the actuator is released, the compressed gas module will quickly repressurize the reservoir, making the motivator 100 ready for another “shot” of gas. Use of a compressed gas cylinder, as described above, might avoid the need for the reservoir.

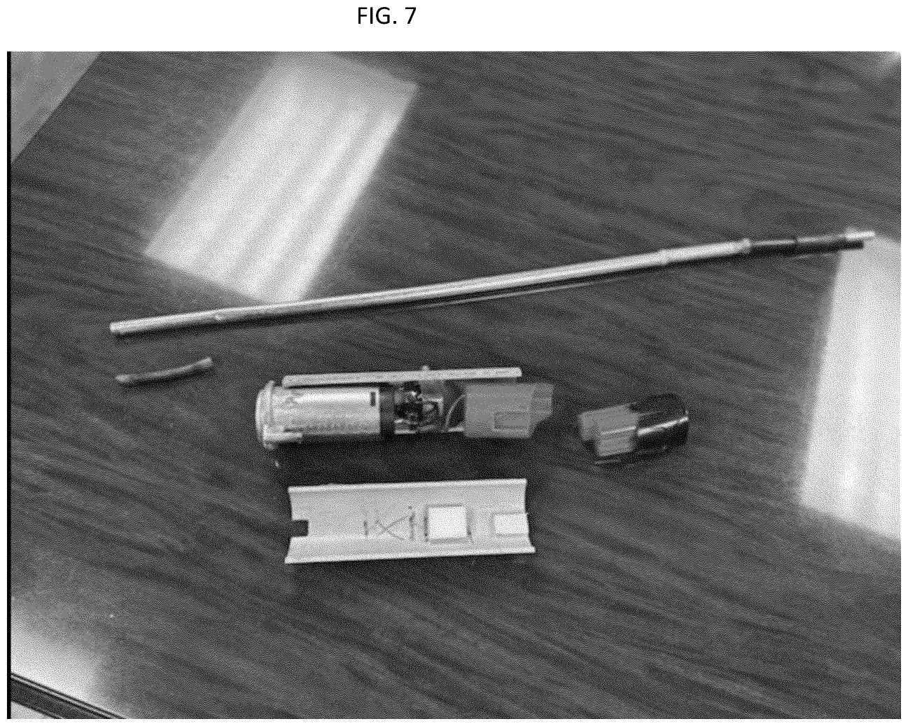

Another alternative construction of the cattle motivator is shown in FIG. 7. In this embodiment, the cattle motivator 100′ includes a compressed gas module 110′ comprising a gas compressor 111′. Unlike the embodiment 100 of FIGS. 1A-B, the cattle motivator 100′ does not include a reservoir, and the outlet of the compressor is placed in direct communication with elongate tube 150, for example, by way of the tubing 112. The gas compressor comprises a highspeed motor 170 powered by a power source (such as a battery). An activator 172, in the form of an on/off switch, activates the highspeed motor which drives air at a high speed through the elongate tube 150. The highspeed motor 150 is capable of driving the air at speed sufficient enough to cause the tip 160 mounted to the end of the elongate tube to produce its sound, to thereby motivate the cattle to move.

Operation of the livestock motivator 100′ is substantially similar to that of the livestock motivator 100. However, because the livestock 100′ does not include a reservoir, use requires only that the tip 160 be pointed at livestock, and that the compressor 111′ (with its highspeed motor) be activated. This will, as noted, force air though the elongate tube 150 and tip 160 at a high rate of speed sufficient to produce a sound with the tip 160 which will motivate cattle to move. The livestock motivator 100′ will produce sound continuously for as long as the compressor 111′ is activated.

As various changes could be made in the above constructions without departing from the scope of the invention, it is intended that all matter contained in the above description or shown in the accompanying drawings shall be interpreted as illustrative and not in a limiting sense.

1. A livestock motivation device comprising:
a compressed gas module comprising a source of compressed gas and having an outlet through which the compressed gas can exit,
an actuator operably connected to exit of the compressed gas module; the actuator comprising a valve and being selectively switchable between an open position in which compressed gas can pass through the actuator and a closed position in which the flow of gas is blocked;
an elongate tube extending from the actuator at an inlet of the tube and having a distal end; and,
a tip removably affixed to the distal end of said elongate tube, said tip being shaped to shape gas flow and generate sound from flowing gas.

2. The livestock motivation device of claim 1 wherein said gas compressor module comprises a canister of compressed gas, the canister of compressed gas being adapted to be removably placed in communication with said tube inlet.

3. The livestock motivation device of claim 1 wherein the compressed gas module comprises an air compressor and a reservoir, the elongate tube being in fluid communication with an outlet of the reservoir.

4. The livestock motivation device of claim 1 wherein said tip comprises:
a noisemaking tip comprising an inlet removably affixed to the distal end of said elongate tube, a hollow passage, and an outlet.

5. The livestock motivation device of claim 3, wherein said noisemaking tip comprises a whistle integrated into the noisemaking tip, the whistle being in fluid communication with said tube, such that said compressed gas passes through said whistle when the motivator is actuated.

6. The livestock motivation device of claim 5, wherein said noisemaking tip further comprises an extension tubing, such that the effective path length of said elongate tubing can be extended; said whistle being at an end of said extension tubing.

7. The livestock motivation device of claim 4, wherein said noisemaking tip further comprises a hollow chamber containing a plurality of small loose objects sized and disposed to generate a rattling sound when gas passes through the hollow chamber.

8. The livestock motivation device of claim 4, further wherein said noisemaking tip further comprises a hollow chamber containing one or more reeds, such that noise is generated when gas passes through the hollow chamber and vibrates said one or more reeds.

9. The livestock motivation device of claim 8, further wherein said noisemaking tip comprises a slide that impinges on one of said one or more reeds at a point of contact, said slide being movable relative to said reed(s) to selectively alter the point of contact between said slide and said reed(s), such that the pitch of the said noise changes when said point of contact is moved via sliding of said slidable clamp.

10. A livestock motivation kit comprising a livestock motivator and a plurality of noisemaking tips;
said livestock motivator comprising:
a source of compressed gas;
a valve operatively connected to an outlet of said source of compressed gas to receive compressed gas from said source of compressed gas; the valve being a normally closed valve;
an actuator operably connected to said valve, said actuator being operable to move said valve between an opened position and a closed position;
an elongate tube comprising a first end and a second end; and said elongate tube being placed in fluid communication with said compressed gas flowing through said tube when said valve is opened;
said noisemaking tips being independently removably affixed to the distal end of said elongate tube, said noisemaking tips being shaped to shape gas flow and generate sound as gas flows through said tip.

11. The kit of claim 10, wherein one of said noisemaking tips comprises a whistle integrated into the noisemaking tip.

12. The kit of claim 10, wherein one of said noisemaking tips comprises a hollow chamber containing a plurality of small loose objects sized and disposed to generate a rattling sound when gas passes through the hollow chamber.

13. The kit of claim 10, wherein one of said noisemaking tips comprises a hollow chamber containing one or more reeds, such that noise is generated when gas passes through the hollow chamber and vibrates said one or more reeds.

14. The kit of claim 13, wherein said noisemaking tip comprises a slide moveable within said tip and positioned to impinge on one of said one or more reeds at a point of contact, whereby the point of contact is selectively changeable such that the pitch of the said noise changes when said point of contact is moved via sliding of said slidable clamp.

15. The kit of claim 10, wherein one of said noisemaking tips comprises an extension tubing, such that the effective path length of said elongate tubing can be extended.
